(19) United States
(12) Patent Application Publication
(10) Pub. No.: US 2016/0155118 A1
(43) Pub. Date: Jun. 2, 2016

(54) Method for Providing Coupon Service and Electronic Device Thereof

(71) Applicant: Samsung Electronics Co., Ltd., Suwon-si (KR)

(72) Inventors: Kyeong-Yun KIM, Seoul (KR); Tae-Kyoung CHO, Seoul (KR); Hye-Sung MIN, Anyang-si (KR); Young-Keun YUN, Seongnam-si (KR); Lo-Wun LEE, Seoul (KR); Sung-Bin JEON, Seoul (KR); Mi-Hyun JEONG, Seoul (KR)

(21) Appl. No.: 14/956,951

(22) Filed: Dec. 2, 2015

(30) Foreign Application Priority Data
Dec. 2, 2014 (KR) 10-2014-0170703

(51) Int. Cl. G06Q 20/38; G06Q 20/32; G06Q 30/02

(52) U.S. Cl. CPC G06Q 20/387; G06Q 30/0222; G06Q 20/3278

(57) ABSTRACT

A method for operating an electronic device according to various exemplary embodiments of the present disclosure includes: receiving a coupon; connecting with at least one of a plurality of second electronic devices; transmitting shared information of the coupon to the at least one of the plurality of second electronic devices connected; connecting with the at least one of the plurality of second electronic devices having the shared information if the coupon is selected; activating the coupon based on a number of the at least one of the plurality of second electronic devices; and transmitting the coupon activated to a payment device.

### RELATED APPLICATION(S)

The present application claims priority under 35 U.S.C. §119 to an application filed in the Korean Intellectual Property Office on Dec. 2, 2014 and assigned Serial No. 10-2014-0170703, the contents of which are incorporated herein by reference.

### BACKGROUND

The present disclosure relate to a method for providing a coupon service and an electronic device thereof.

With the developments of information and communications technology and semiconductor technology, various kinds of electronic devices are developing into multimedia devices to provide various multimedia services. For example, the electronic device provides various multimedia services such as a messenger service, a broadcasting service, a wireless Internet service, a camera service, and a music replay service.

Such an electronic device may be provided with coupons having various benefits through a web server online. For example, a store which provides coupon benefits may offer a discount on food or goods to a user who owns a coupon, or offer specific food or goods free. For the purpose of attracting customers in groups, the store may provide a coupon service which provides a different benefit (e.g., a discount on food or goods, or a free service of food or goods) according to the number of users when more than a predetermined number of customers in groups visit the store.

In a related-art coupon service providing method, a retailer may check users' respective coupons one by one with his/her naked eyes in order to provide coupon benefits to a plurality of users such as customers in groups. In addition, when a coupon provides a different benefit according to the number of users, the retailer may count the users one by one. Therefore, it may be time-consuming to provide a coupon benefit in the case of customers in groups.

### SUMMARY

To address the above-discussed deficiencies, it is a primary object to provide a method for providing a coupon service, which can share a coupon with other electronic devices, and an electronic device thereof.

Another object of the present disclosure is to provide a method for providing a coupon service, which links electronic devices having the same coupon and activates a coupon based on the linked electronic devices, and an electronic device thereof.

According to an aspect of the present disclosure, a method for operating an electronic device includes: receiving a coupon; connecting with at least one electronic device; transmitting shared information of the coupon to the at least one electronic device connected; connecting with the at least one electronic device having the shared information if the coupon is selected; activating the coupon based on a number of the at least one electronic device; and transmitting the coupon activated to a payment device.

According to another aspect of the present disclosure, an electronic device includes: a communication interface; and at least one processor functionally connected with the communication interface, the processor is configured to: connect with at least one electronic device if a coupon is received; transmit shared information of the coupon to the at least one electronic device connected; connect with the at least one electronic device having the shared information if the coupon is selected; activate the coupon based on a number of the at least one electronic device connected; and transmit the coupon activated to a payment device.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a block diagram of an electronic device according to various exemplary embodiments of the present disclosure;

FIG. 2 illustrates a block diagram of a network environment for providing a coupon service according to various exemplary embodiments of the present disclosure;

FIG. 3 illustrates a flowchart of an operation method in a network environment for providing a coupon service according to various exemplary embodiments;

FIG. 4 illustrates a flowchart of a method for activating a coupon based on a number of connected electronic devices to an electronic device according to various exemplary embodiments of the present disclosure;

FIG. 5 illustrates a view showing a method for activating a coupon in an electronic device according to various exemplary embodiments of the present disclosure;

FIG. 6 illustrates a flowchart showing an operation method of an electronic device which receives shared information of a coupon according to various exemplary embodiments of the present disclosure;

FIG. 7 illustrates a flowchart showing an operation method of a server for providing a coupon service according to various exemplary embodiments of the present disclosure;

FIG. 8 illustrates a sequence diagram of an operation in a network environment for providing a coupon service according to various exemplary embodiments of the present disclosure;

FIG. 9 illustrates a sequence diagram of an operation in a network environment for providing a coupon service according to various exemplary embodiments of the present disclosure;

FIG. 10 illustrates a sequence diagram of an operation in a network environment for providing a coupon service according to various exemplary embodiments of the present disclosure; and

FIG. 11 illustrates a flowchart showing an operation method of an electronic device for providing a coupon service according to various exemplary embodiments of the present disclosure.

### DETAILED DESCRIPTION

Hereinafter, various embodiments of the present disclosure will be described with reference to the accompanying drawings. In the following description, specific details such as detailed configuration and components are merely provided to assist the overall understanding of these embodiments of the present disclosure. Therefore, it should be apparent to those skilled in the art that various changes and modifications of the embodiments described herein can be made without departing from the present disclosure. In addition, descriptions of well-known functions and implementations are omitted for clarity and conciseness.

The present disclosure may have various embodiments, and modifications and changes may be made therein. Therefore, the present disclosure will be described in detail with reference to particular embodiments shown in the accompanying drawings. However, it should be understood that the present disclosure is not limited to the particular embodiments, but includes all modifications/changes, equivalents, and/or alternatives falling within the present disclosure. In describing the drawings, similar reference numerals may be used to designate similar elements.

The terms “have”, “may have”, “include”, or “may include” used in the various embodiments of the present disclosure indicate the presence of disclosed corresponding functions, operations, elements, and the like, and do not limit additional one or more functions, operations, elements, and the like. In addition, it should be understood that the terms “include” or “have” used in the various embodiments of the present disclosure are to indicate the presence of features, numbers, steps, operations, elements, parts, or a combination thereof described in the specifications, and do not preclude the presence or addition of one or more other features, numbers, steps, operations, elements, parts, or a combination thereof.

The terms “A or B”, “at least one of A or/and B” or “one or more of A or/and B” used in the various embodiments of the present disclosure include any and all combinations of words enumerated with it. For example, “A or B”, “at least one of A and B” or “at least one of A or B” means (1) including at least one A, (2) including at least one B, or (3) including both at least one A and at least one B.

Although the term such as “first” and “second” used in various embodiments of the present disclosure may modify various elements of various embodiments, these terms do not limit the corresponding elements. For example, these terms do not limit an order and/or importance of the corresponding elements. These terms may be used for the purpose of distinguishing one element from another element. For example, a first user device and a second user device all indicate user devices and may indicate different user devices. For example, a first element may be named a second element without departing from the various embodiments of the present disclosure, and similarly, a second element may be named a first element.

It will be understood that when an element (e.g., first element) is “connected to” or “(operatively or communicatively) coupled with/to” to another element (e.g., second element), the element may be directly connected or coupled to another element, and there may be an intervening element (e.g., third element) between the element and another element. To the contrary, it will be understood that when an element (e.g., first element) is “directly connected” or “directly coupled” to another element (e.g., second element), there is no intervening element (e.g., third element) between the element and another element.

The expression “configured to (or set to)” used in various embodiments of the present disclosure may be replaced with “suitable for”, “having the capacity to”, “designed to”, “adapted to”, “made to”, or “capable of” according to a situation. The term “configured to (set to)” does not necessarily mean “specifically designed to” in a hardware level. Instead, the expression “apparatus configured to . . . ” may mean that the apparatus is “capable of . . . ” along with other devices or parts in a certain situation. For example, “a processor configured to (set to) perform A, B, and C” may be a dedicated processor, e.g., an embedded processor, for performing a corresponding operation, or a generic-purpose processor, e.g., a Central Processing Unit (CPU) or an application processor (AP), capable of performing a corresponding operation by executing one or more software programs stored in a memory device.

The terms as used herein are used merely to describe certain embodiments and are not intended to limit the present disclosure. As used herein, singular forms may include plural forms as well unless the context explicitly indicates otherwise. Further, all the terms used herein, including technical and scientific terms, should be interpreted to have the same meanings as commonly understood by those skilled in the art to which the present disclosure pertains, and should not be interpreted to have ideal or excessively formal meanings unless explicitly defined in various embodiments of the present disclosure.

The module or program module according to various embodiments of the present disclosure may further include at least one or more constitutional elements among the aforementioned constitutional elements, or may omit some of them, or may further include additional other constitutional elements. Operations performed by a module, programming module, or other constitutional elements according to various embodiments of the present disclosure may be executed in a sequential, parallel, repetitive, or heuristic manner. In addition, some of the operations may be executed in a different order or may be omitted, or other operations may be added.

An electronic device according to various embodiments of the present disclosure may be a device. For example, the electronic device according to various embodiments of the present disclosure may include at least one of: a smart phone; a tablet personal computer (PC); a mobile phone; a video phone; an e-book reader; a desktop PC; a laptop PC; a netbook computer; a workstation, a server, a personal digital assistant (PDA); a portable multimedia player (PMP); an MP3 player; a mobile medical device; a camera; or a wearable device (e.g., a head-mount-device (HMD), an electronic glasses, an electronic clothing, an electronic bracelet, an electronic necklace, an electronic appcessory, an electronic tattoo, a smart mirror, or a smart watch).

In other embodiments, an electronic device may be a smart home appliance. For example, of such appliances may include at least one of: a television (TV); a digital video disk (DVD) player; an audio component; a refrigerator; an air conditioner; a vacuum cleaner; an oven; a microwave oven; a washing machine; an air cleaner; a set-top box; a home automation control panel; a security control panel; a TV box (e.g., Samsung HomeSync®, Apple TV®, or Google TV); a game console (e.g., Xbox® PlayStation®); an electronic dictionary; an electronic key; a camcorder; or an electronic frame.

In other embodiments, an electronic device may include at least one of: a medical equipment (e.g., a mobile medical device (e.g., a blood glucose monitoring device, a heart rate monitor, a blood pressure monitoring device or a temperature meter), a magnetic resonance angiography (MRA) machine, a magnetic resonance imaging (MRI) machine, a computed tomography (CT) scanner, or an ultrasound machine); a navigation device; a global positioning system (GPS) receiver; an event data recorder (EDR); a flight data recorder (FDR); an in-vehicle infotainment device; an electronic equipment for a ship (e.g., ship navigation equipment and/or a gyrocompass); an avionics equipment; a security equipment; a head unit for vehicle; an industrial or home robot; an automated teller's machine (ATM) of a financial institution, point of sale (POS) device at a retail store, or an internet of things device (e.g., a Lightbulb, various sensors, an electronic meter, a gas meter, a sprinkler, a fire alarm, a thermostat, a streetlamp, a toaster, a sporting equipment, a hot-water tank, a heater, or a boiler and the like)

In certain embodiments, an electronic device may include at least one of: a piece of furniture or a building/structure; an electronic board; an electronic signature receiving device; a projector; or various measuring instruments (e.g., a water meter, an electricity meter, a gas meter, or a wave meter).

An electronic device according to various embodiments of the present disclosure may also include a combination of one or more of the above-mentioned devices.

Further, it will be apparent to those skilled in the art that an electronic device according to various embodiments of the present disclosure is not limited to the above-mentioned devices.

Herein, the term “user” may indicate a person who uses an electronic device or a device (e.g., an artificial intelligence electronic device) that uses the electronic device.

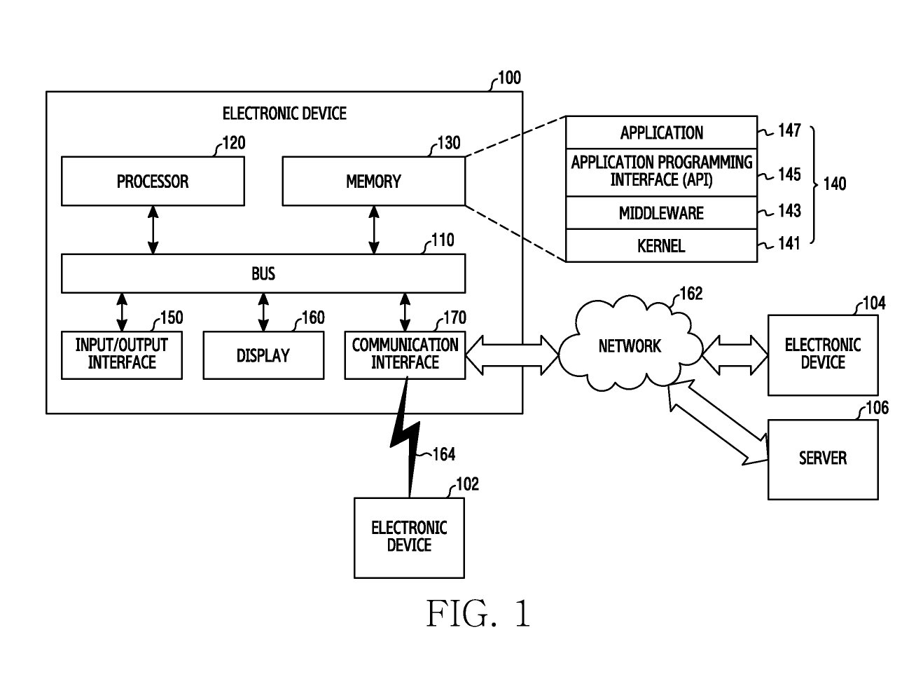

FIG. 1 is a block diagram of an electronic device according to an embodiment of the present disclosure.

Referring to FIG. 1, an electronic device 100 may include a bus 110, a processor 120, a memory 130, an input/output interface 150, a display 160, and a communication interface 170. In some embodiments, the display 160 may be a touch screen. According to various embodiments of the present disclosure, at least one of the components of the electronic device 100 may be omitted, or other components may be additionally included in the electronic device 100.

The bus 110 may be a circuit that connects the processor 120, the memory 130, the input/output interface 150, the display 160, or the communication interface 170 and transmits communication (e.g., control messages) between the above described components.

The processor 120 may carry out operations or data processing related to control and/or communication of at least one other component (e.g., the memory 130, the input/output interface 150, the display 160, or the communication interface 170) of the electronic device 100.

According to various exemplary embodiments, the processor 120 may receive a coupon from a server 106 or a service provider via the communication interface 170. When the coupon is received, the processor 120 may be functionally connected with at least one electronic device (e.g., a first external electronic device 102, a second external electronic device 104, and the like.), and may transmit at least one of the coupon or shared information of the coupon to the connected electronic device. Herein, the shared information of the coupon may include at least one of identification information of the electronic device 100, identification information of the coupon, or resource information of the coupon. For example, the identification information of the electronic device 100 may include an ID, an identifier, and the like of the electronic device 100. The identification information of the coupon may include a coupon number of the coupon, information on a store where the coupon can be used, or information on goods to which the coupon can be applied. The resource information of the coupon may include source information of the coupon such as a uniform resource locator (URL) address of a server from which the coupon can be provided (e.g., the server 106), and the like.

According to various exemplary embodiments, when the coupon is selected, the processor 120 may be functionally connected with the electronic device having the shared information of the coupon, and may activate the coupon based on the number of connected electronic devices. According to the selection of the coupon, the processor 120 may serve as an Access Point (AP) which performs short-distance communication including at least one of WiFi communication, Bluetooth communication, or Near Field Communication (NFC).

According to various exemplary embodiments, the processor 120 may set a password for connecting with the electronic device having the shared information, and may receive a password from the electronic device having the shared information and may be connected with the electronic device having the shared information based on the received password.

The processor 120 may identify at least one electronic device which is located within the communication range of the above-described communication, and try to connect communication with the respective electronic devices. For example, the processor 120 may try to connect communication only with the electronic device having the same coupon, and may receive coupon information from the corresponding electronic devices. Therefore, the processor 120 may identify the number of connected electronic devices based on the coupon information received from the respective electronic devices.

For example, when the number of connected electronic devices is greater than or equal to a reference number, the processor 120 may activate the corresponding coupon. According to various exemplary embodiments, the processor 120 may activate the coupon by applying a different coupon benefit according to the number of connected electronic devices (e.g., by applying a different discount rate according to the number of members in a group). The processor 120 may transmit activation information on the activated coupon to a payment device (e.g., a service provider, a server, or the like). The processor 120 may receive payment information on the coupon from the payment device.

The memory 130 includes at least one of the other elements in the non-volatile memories. The memory 130 may store commands or data (e.g., a reference pattern or a reference touch area) associated with one or more other components of the electronic device 100. According to one embodiment, the memory 130 may store software and/or a program 140. For example, the program 140 may include a kernel 141, a middleware 143, an Application Programming Interface or API 145, an application 147, or the like. At least some of the kernel 141, the middleware 143, and the API 145 may be referred to as an Operating System (OS).

The kernel 141 may control or manage system resources (e.g., the bus 110, the processor 120, or the memory 130) used for performing an operation or function implemented by the other programs (e.g., the middleware 143, the API 145, or the application 147). Furthermore, the kernel 141 may provide an interface through which the middleware 143, the API 145, or the application 147 may access the individual elements of the electronic device 100 to control or manage the system resources.

The middleware 143, for example, may function as an intermediary for allowing the API 145 or the application 147 to communicate with the kernel 141 to exchange data.

In addition, the middleware 143 may process one or more task requests received from the application 147 according to priorities thereof. For example, the middleware 143 may assign priorities for using the system resources (e.g., the bus 110, the processor 120, the memory 130, or the like) of the electronic device 100, to at least one of the application 147. For example, the middleware 143 may perform scheduling or loading balancing on the one or more task requests by processing the one or more task requests according to the priorities assigned thereto.

The API 145 is an interface through which the application 147 control functions provided from the kernel 141 or the middleware 143, and may include, for example, at least one interface or function (e.g., instruction) for file control, window control, image processing, or text control.

The input/output interface 150 may forward instructions or data input from a user through an input/output device (e.g., various sensors, such as an acceleration sensor or a gyro sensor, and/or a device such as a keyboard or a touch screen), to the processor 120, the memory 130, or the communication interface 170 through the bus 110. For example, the input/output interface 150 may provide the processor 120 with data on a user's touch entered on a touch screen. Furthermore, the input/output interface 150 may output instructions or data, received from, for example, the processor 120, the memory 130, or the communication interface 170 via the bus 110, through an output unit (e.g., a speaker or the display 160).

The display 160 may include, for example, a liquid crystal display (LCD), a light emitting diode (LED) display, an organic LED (OLED) display, a micro electro mechanical system (MEMS) display, an electronic paper display, and the like. The display 160, for example, may display various types of content (e.g., a text, images, videos, icons, symbols, and the like) for the user. The display 160 may include a touch screen and receive, for example, a touch, a gesture, proximity, a hovering input, and the like, using an electronic pen or the user's body part. According to an embodiment of the present disclosure, the display 160 may display a web page.

The communication interface 170, for example, may set communication between the electronic device 100 and an external device (e.g., the first external electronic device 102, the second external electronic device 104, or the server 106). For example, the communication interface 170 may be connected to a network 162 through wireless or wired communication to communicate with the external device (e.g., the second external electronic device 104 or the server 106).

The wireless communication may include at least one of, for example, Wi-Fi, Bluetooth (BT), near field communication (NFC), a global positioning system (GPS), and cellular communication (e.g., Long-Term Evolution (LTE), Long-Term Evolution-Advanced (LTE-A), code division multiple access (CDMA), wideband code division multiple access (WCDMA), Universal Mobile Telecommunications System (UMTS), Wireless Broadband (WiBro), Global System for Mobile Communications (GSM), etc.). The wired communication may include at least one of, for example, a universal serial bus (USB), a high definition multimedia interface (HDMI), Recommended Standard 232 (RS-232), and a plain old telephone Service (POTS).

The network 162 may be a telecommunication network. The communication network may include at least one of a computer network, the Internet, the Internet of Things, and a telephone network.

The first external electronic device 102 and the second external electronic device 104 may be devices that are the same as or different from the electronic device 100.

The server 106 may include at least one server group. According to an embodiment, the server 106 may support the driving of the electronic device 100 by performing at least one of the operations (or functions) implemented in the electronic device 100.

The first external electronic device 102 and the second external electronic device 104 may be devices that are the same as or different from the electronic device 100. According to an embodiment of the present disclosure, the server 106 may include a group of one or more servers. According to various embodiments of the present disclosure, some or all operations performed in the electronic device 100 can be performed in the other electronic device or multiple electronic devices (e.g., the first external electronic device 102 or the second external electronic device 104 or the server 106). According to an embodiment of the present disclosure, when the electronic device 100 may perform some functions or services automatically or by a request, the electronic device 100 may make a request for performing at least some functions related to the functions or services to another device (e.g., the first external electronic device 102 or the second external electronic device 104, or the server 106) instead of performing the functions or services by itself or additionally. Another electronic device (e.g., the first external electronic device 102 or the second external electronic device 104, or the server 106) may perform a function requested from the electronic device 100 or an additional function and transfer the performed result to the electronic device 100. The electronic device 100 can provide the requested function or service to another electronic device by processing the received result as it is or additionally. To this end, for example, cloud computing, distributed computing, or client-server computing technology may be used.

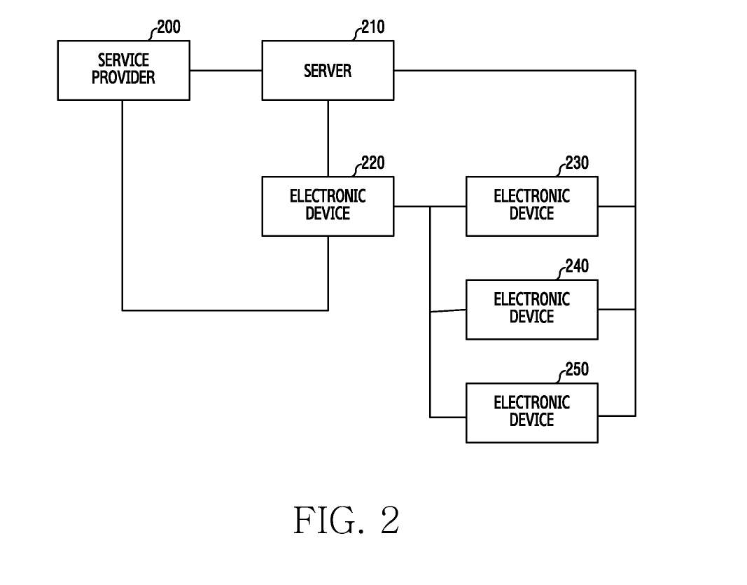

FIG. 2 illustrates a block diagram of a network environment for providing a coupon service according to various exemplary embodiments of the present disclosure.

Referring to FIG. 2, the network environment for providing the coupon service may include a service provider 200, a server 210, an electronic device 220, and at least one electronic device connected to the electronic device 220 (e.g., an electronic device 230, an electronic device 240, and an electronic device 250). According to various exemplary embodiments, the at least one electronic device (e.g., the electronic device 230, the electronic device 240, and the electronic device 250) may be configured in the same way as the electronic device 220.

According to various exemplary embodiments, the service provider 200 may transmit a coupon registration request to the server 210, and may receive activation information on a coupon from the electronic device 220.

According to various exemplary embodiments, the server 210 may receive a coupon registration request from the service provider 200, and transmit a coupon to the electronic device 220 in response to the coupon registration request. In addition, the server 210 may receive a coupon transmission request from at least one of the electronic device 230, the electronic device 240, and the electronic device 250, connected to the electronic device 220, and transmit a coupon to the at least one of the electronic device 230, the electronic device 240, and the electronic device 250, in response to the coupon transmission request.

According to various exemplary embodiments, the electronic device 220 may receive a coupon from the server 210. The electronic device 220 may transmit shared information of the coupon to the at least one electronic device (e.g., the electronic device 230, the electronic device 240, and the electronic device 250) connected to the electronic device 220. The shared information of the coupon may include at least one of identification information of the electronic device which receives the coupon, identification information of the coupon, or resource information of the coupon. For example, the identification information of the electronic device may include an ID, an identifier, and the like of the electronic device. The identification information of the coupon may include a coupon number of the coupon, information on a store in which the coupon can be used, information on goods to which the coupon can be applied, and the like. The resource information of the coupon may include source information of the coupon such as a URL address of a server from which the coupon is provided, and the like.

According to various exemplary embodiments, when the coupon is selected, the electronic device 220 may be automatically connected with the electronic device having the shared information (e.g., the electronic device 230, the electronic device 240, and the electronic device 250). For example, the electronic device 220 may transform to a connection standby state by selecting the coupon. Thereafter, the electronic device 220 may serve as an AP which performs short-distance communication including at least one of WiFi communication, Bluetooth communication, or NFC. When the electronic device 220 detects an electronic device having the shared information within the communication range of the above-described communication, the electronic device 220 may be connected with the corresponding electronic device.

According to various exemplary embodiments, the electronic device 220 may activate the coupon based on the number of connected electronic devices. For example, the coupon may be an inactivated coupon, and the electronic device 220 may activate the corresponding coupon when the number of connected electronic devices is greater than or equal to a predetermined number. According to various exemplary embodiments, the electronic device 220 may activate the coupon by applying a different coupon benefit according to the number of connected electronic devices (e.g., by applying a different discount rate according to the number of members in a group). The electronic device 220 may transmit activation information on the activated coupon to the service provider 200 or the server 210.

According to various exemplary embodiments, the at least one electronic device (e.g., the electronic device 230, the electronic device 240, and the electronic device 250) connected to the electronic device 220 may receive the shared information of the coupon from the electronic device 220, and may transmit a coupon transmission request to the server 210 through the resource information included in the shared information. The at least one electronic device (e.g., the electronic device 230, the electronic device 240, and the electronic device 250) may receive the corresponding coupon from the server 210, and may be connected with the electronic device 220 via short-distance communication by executing a coupon-related application or selecting the coupon.

An electronic device according to various exemplary embodiments may include: a communication interface; and at least one processor functionally connected with the communication interface, and the processor may be configured to: when a coupon is received, functionally connect with at least one electronic device; transmit shared information of the coupon to the connected electronic device; when the coupon is selected, functionally connect with the electronic device having the shared information; activate the coupon based on a number of the connected electronic devices; and transmit the activated coupon to a payment device.

According to various exemplary embodiments, the shared information may include at least one of identification information of the electronic device, identification information of the coupon, or resource information of the coupon.

According to various exemplary embodiments, the processor may be configured to connect with the electronic device having the shared information through short-distance communication.

According to various exemplary embodiments, the processor may be configured to: set a password for connecting with the electronic device having the shared information; receive a password from the electronic device having the shared information; and connect with the electronic device having the shared information based on the received password.

According to various exemplary embodiments, the short-distance communication may include at least one of WiFi communication, Bluetooth communication, or NFC.

According to various exemplary embodiments, the processor may be configured to receive the coupon from a server or a service provider.

According to various exemplary embodiments, the processor may be configured to transmit the shared information of the coupon and the coupon to the connected electronic device.

According to various exemplary embodiments, the processor may be configured to receive payment information on the coupon from the payment device.

According to various exemplary embodiments, the processor may be configured to: receive shared information of a coupon from the connected electronic device; request the coupon from the payment device; receive the requested coupon; and, when the coupon is selected, transmit coupon information of the coupon to the connected electronic device.

According to various exemplary embodiments, when the shared information of the coupon is received, the processor may be configured to determine whether the electronic device owns the coupon or not, and, when the electronic device owns the coupon, the processor may be configured not to request the coupon.

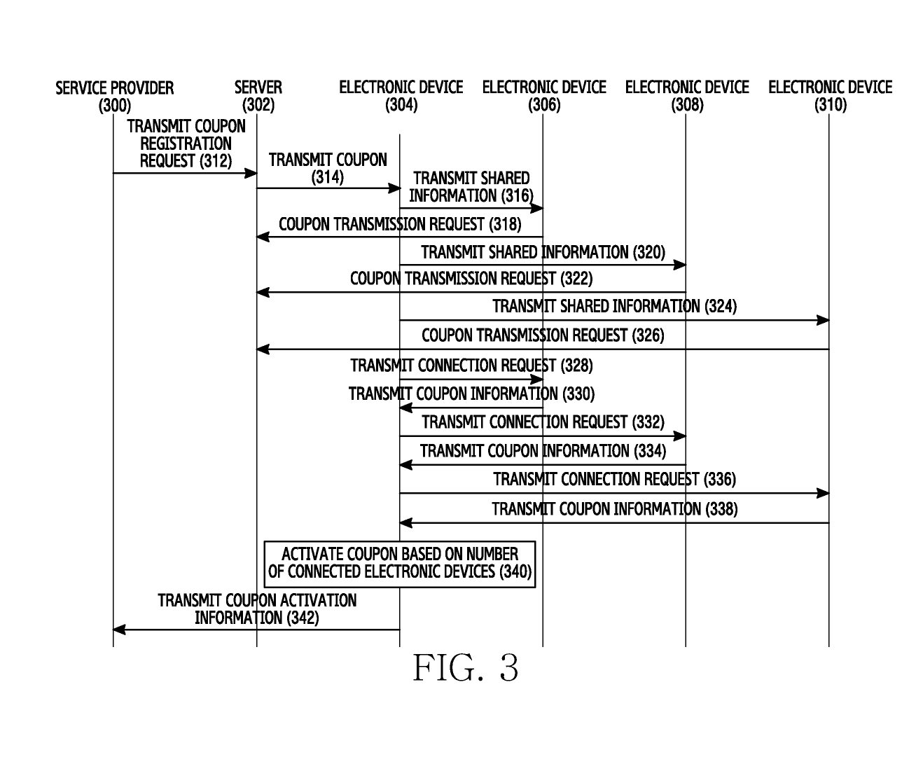

FIG. 3 illustrates a flowchart showing an operation method in a network environment for providing a coupon service according to various exemplary embodiments of the present disclosure.

Referring to FIG. 3, the network environment for providing the coupon service may include a service provider 300, a server 302, an electronic device 304, and at least one electronic device (e.g., an electronic device 306, an electronic device 308, an electronic device 310, and the like) connected to the electronic device 304.

In operation 312, the service provider 300 may transmit a coupon registration request to the server 302. Thereafter, the server 302 may transmit a corresponding coupon to the electronic device 304. The electronic device 304 which receives the coupon may transmit shared information of the coupon to the at least one electronic device (e.g., the electronic device 306, the electronic device 308, the electronic device 310, and the like) connected to the electronic device 304 (operations 316, 320, and 324). In response to the shared information being transmitted, the at least one electronic device (e.g., the electronic device 306, the electronic device 308, the electronic device 310, and the like) connected to the electronic device 304 may request the server 302 to transmit the coupon through resource information included in the shared information (operations 318, 322, and 326). Accordingly, the at least one electronic device (e.g., the electronic device 306, the electronic device 308, the electronic device 310, and the like) may receive the same coupon from the server 302.

Thereafter, the electronic device 304 may transmit a connection request to the at least one electronic device (e.g., the electronic device 306, the electronic device 308, the electronic device 310, and the like) connected thereto (operations 328, 332, and 336). For example, the electronic device 304 may be connected with the at least one electronic device (e.g., the electronic device 306, the electronic device 308, the electronic device 310, and the like) via short-distance communication. In response to the connection request being transmitted, the at least one electronic device (e.g., the electronic device 306, the electronic device 308, the electronic device 310, and the like) may transmit coupon information of the coupon to the electronic device 304 (operations 330, 334, 338).

Thereafter, in operation 340, the electronic device 304 may activate the coupon based on the number of connected electronic devices. For example, the electronic device 304 may check the number of connected electronic devices according to the coupon information received from the at least one electronic device (e.g., the electronic device 306, the electronic device 308, the electronic device 310, and the like).

In operation 342, the electronic device 304 may transmit coupon activation information to the service provider 300.

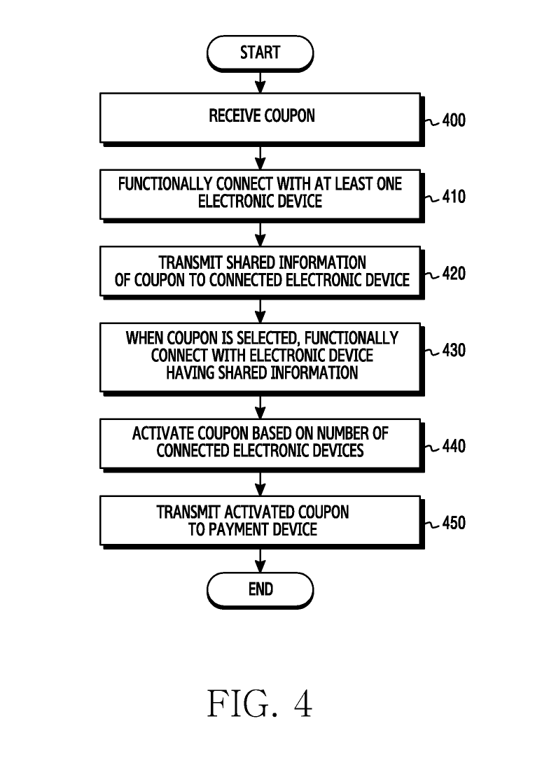

FIG. 4 illustrates a flowchart showing a method for activating a coupon based on the number of connected electronic devices in an electronic device according to various exemplary embodiments of the present disclosure.

Referring to FIG. 4, in operation 400, an electronic device (e.g., the electronic device 100) may receive a coupon. For example, the electronic device may receive the coupon from at least one of a server, a service provider, or a payment device. Herein, the coupon may be an inactivated coupon.

In operation 410, the electronic device may be functionally connected with at least one electronic device. For example, the electronic device may connect communication with at least one electronic device through a communication interface.

In operation 420, the electronic device may transmit shared information of the coupon to the connected electronic device. Herein, the shared information of the coupon may include at least one of identification information of the electronic device which receives the coupon, identification information of the coupon, or resource information of the coupon. For example, the identification information of the electronic device may include an ID, an identifier, and the like of the electronic device. The identification information of the coupon may include a coupon number of the coupon, information on a store in which the coupon can be used, information on goods to which the coupon can be applied, and the like. The resource information of the coupon may include source information of the coupon such as a URL address of a server from which the coupon is provided, and the like.

According to various exemplary embodiments, the at least one electronic device which receives the shared information may transmit a coupon transmission request to the server through the resource information included in the shared information, and may receive the corresponding coupon from the server.

According to various exemplary embodiments, the electronic device may transmit the shared information of the coupon and the corresponding coupon to the connected electronic device.

Accordingly, the electronic device and the at least one electronic device connected to the electronic device may have the same coupon.

In operation 430, when the coupon is selected, the electronic device may be functionally connected with the electronic device having the shared information.

According to various exemplary embodiments, when the coupon is selected, the electronic device may be automatically connected with the electronic device having the shared information. For example, the electronic device may transform to a connection standby state by selecting the coupon. Thereafter, the electronic device may serve as an AP which performs short-distance communication including at least one of WiFi communication, Bluetooth communication, or NFC. When the electronic device detects an electronic device having the shared information within the communication range of the above-described communication, the electronic device may be connected with the corresponding electronic device.

According to various exemplary embodiments, when the coupon is selected, the electronic device may be manually connected with the electronic device having the shared information. For example, the electronic device may transform to a connection standby state by selecting the coupon. Thereafter, the electronic device may serve as an AP which performs short-distance communication including at least one of WiFi communication, Bluetooth communication, or NFC. When the corresponding coupon is selected while the electronic device having the shared information is located within the communication range of the above-described communication, the electronic device may be connected with the electronic device serving as the AP.

According to various exemplary embodiments, the electronic device may set a password for connecting with the electronic device having the shared information. For example, the electronic device may receive a password from the electronic device having the shared information, and may be connected with the electronic device having the shared information based on the received password.

In operation 440, the electronic device may active the coupon based on the number of connected electronic devices. For example, the coupon may be an inactivated coupon, and the electronic device may activate the corresponding coupon when the number of connected electronic devices is greater than or equal to a reference number.

According to various exemplary embodiments, the electronic device may activate the coupon by applying a different coupon benefit according to the number of connected electronic devices (e.g., by applying a different discount rate according to the number of members in a group).

In operation 450, the electronic device may transmit the activated coupon to a payment device. Herein, the payment device may include a server or a service provider related to the coupon. The electronic device may finish the use of the coupon by transmitting the activated coupon to the payment device. The electronic device may receive payment information on the coupon from the payment device.

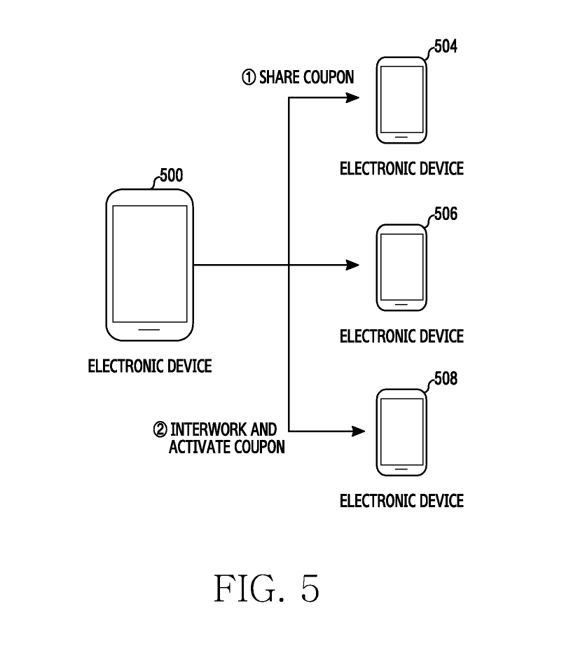

FIG. 5 illustrates a view showing a method for activating a coupon in an electronic device 500 according to various exemplary embodiments of the present disclosure.

Referring to FIG. 5, when sharing a coupon with a connected second electronic device (e.g., one of electronic devices 504, 506, 508), an electronic device may transmit shared information of the coupon. Herein, the shared information of the coupon may include at least one of identification information of the electronic device 500 which receives the coupon, identification information of the coupon, or resource information of the coupon. For example, the identification information of the electronic device 500 may include an ID, an identifier, and the like of the electronic device 500. The identification information of the coupon may include a serial number of the coupon, information on a store in which the coupon can be used, information on goods to which the coupon can be applied, and the like. The resource information of the coupon may include source information of the coupon such as a URL address of a server from which the coupon is provided, and the like.

According to various exemplary embodiments, when the coupon is selected, the electronic device 500 may be automatically connected with the second electronic device (e.g., one of electronic devices 504, 506, 508) having the shared information. For example, the electronic device may transform to a connection standby state by selecting one of the coupons that the electronic device 500 owns. Thereafter, the electronic device 500 may serve as an AP which performs short-distance communication including at least one of WiFi communication, Bluetooth communication, or NFC. Thereafter, when the second electronic device (e.g., one of electronic devices 504, 506, 508) having the shared information is located within the communication range of the above-described communication and executes a coupon-related application, the second electronic device (e.g., one of electronic devices 504, 506, 508) may be automatically connected with the electronic device 500 serving as the AP. Accordingly, the coupon of the electronic device 500 may be interworked and recognized with the coupons of the connected electronic device (e.g., one of electronic devices 504, 506, 508), and, when an activating condition pre-defined for the corresponding coupon (e.g., more than a reference number of connected electronic devices) is satisfied, the coupon of the electronic device 500 may be activated.

According to various exemplary embodiments, when the coupon is selected, the electronic device 500 may be manually connected with the second electronic device (e.g., electronic devices 504, 506, 508) having the shared information. For example, the electronic device may transform to a connection standby state by selecting one of the coupons that the electronic device 500 owns. Thereafter, the electronic device 500 may serve as an AP which performs short-distance communication including at least one of WiFi communication, Bluetooth communication, and NFC communication. Thereafter, when the electronic device 500 selects the corresponding coupon, and the second electronic device (e.g., one of electronic devices 504, 506, 508) having the shared information is located within the communication range of the above-described communication and selects the same coupon as the electronic device 500, the electronic device (e.g., one of electronic devices 504, 506, 508) may be connected with the electronic device 500 serving as the AP. For example, when the electronic device 500 serving as the AP sets a password for communication, the electronic device 500 may receive passwords from the respective second electronic devices (e.g., one of electronic devices 504, 506, 508) and may be connected with the electronic device 500 having the shared information based on the received passwords. Accordingly, the coupon of the electronic device 500 may be recognized in combination with the coupons of the connected electronic device (e.g., one of electronic devices 504, 506, 508), and, when an activating condition pre-defined for the corresponding coupon (e.g., more than a reference number of connected electronic device) is satisfied, the coupon of the electronic device 500 may be activated.

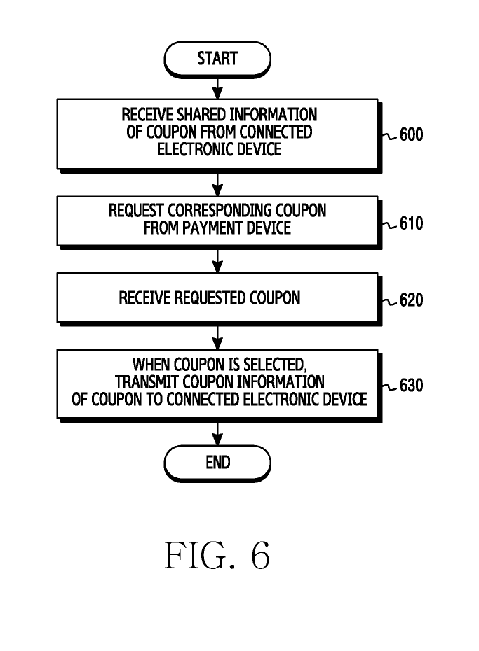

FIG. 6 illustrates a flowchart showing an operation method of an electronic device which receives shared information of a coupon according to various exemplary embodiments of the present disclosure.

Referring to FIG. 6, in operation 600, an electronic device (e.g., the electronic device 100) may receive shared information of a coupon from an electronic device connected thereto. Herein, the shared information of the coupon may include at least one of identification information of the electronic device which transmits the shared information of the coupon, identification information of the coupon, or resource information of the coupon. For example, the identification information of the electronic device may include an ID, an identifier, and the like of the electronic device. The identification information of the coupon may include a serial number of the coupon, information on a store in which the coupon can be used, information on goods to which the coupon can be applied, and the like. The resource information of the coupon may include source information of the coupon such as a URL address of a server from which the coupon is provided, and the like.

In operation 610, the electronic device may request a corresponding coupon from a payment device. Herein, the payment device may include a server or a service provider. According to various exemplary embodiments, the electronic device may transmit a coupon transmission request to the server through the resource information included in the shared information, and the electronic device may receive the requested coupon in operation 620.

In operation 630, when the coupon is selected, the electronic device may transmit the coupon information of the coupon to the connected electronic device. According to various exemplary embodiments, when the electronic device is located within the range of short-distance communication (e.g., WiFi communication, Bluetooth communication, NFC communication, and the like) with the electronic device providing the shared information of the coupon, and executes a coupon-related application or selects the corresponding coupon, the electronic device may transmit the coupon information of the coupon to the electronic device.

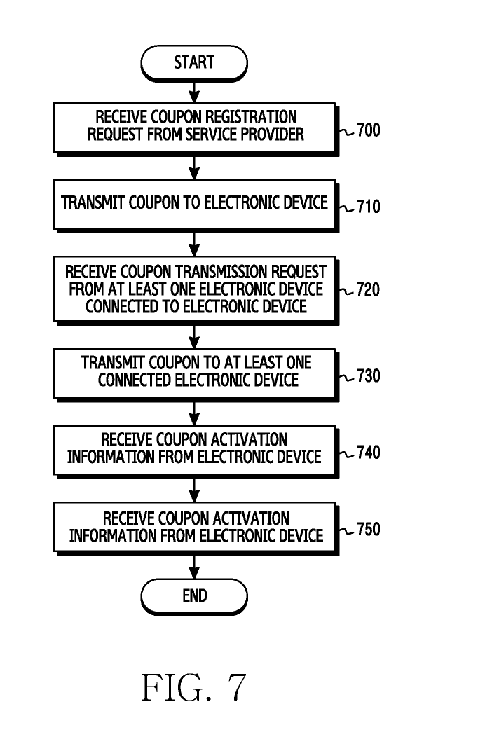

FIG. 7 illustrates a flowchart showing an operation method of a server for providing a coupon service according to various exemplary embodiments of the present disclosure.

Referring to FIG. 7, in operation 700, a server (e.g., the server 106) may receive a coupon registration request from a service provider. For example, the server may receive a coupon registration request signal on a specific coupon from the service provider.

In operation 710, the server may transmit a coupon to an electronic device. Herein, the coupon may be an inactivated coupon. According various exemplary embodiments, the server may receive a coupon transmission request signal from the electronic device and transmit a corresponding coupon to the electronic device.

In operation 720, the server may receive a coupon transmission request from at least one electronic device connected to the electronic device. Herein, the at least one electronic device connected to the electronic device may receive shared information of the coupon from the electronic device, and may transmit a coupon transmission request signal to the server through resource information included in the shared information.

In operation 730, the server may transmit a coupon to the at least one connected electronic device.

In operation 740, the server may receive coupon activation information from the electronic device. For example, the electronic device may transmit, to the server, the coupon activation information on the coupon which is activated based on the number of connected electronic devices.

In operation 750, the server may transmit the coupon activation information to the service provider.

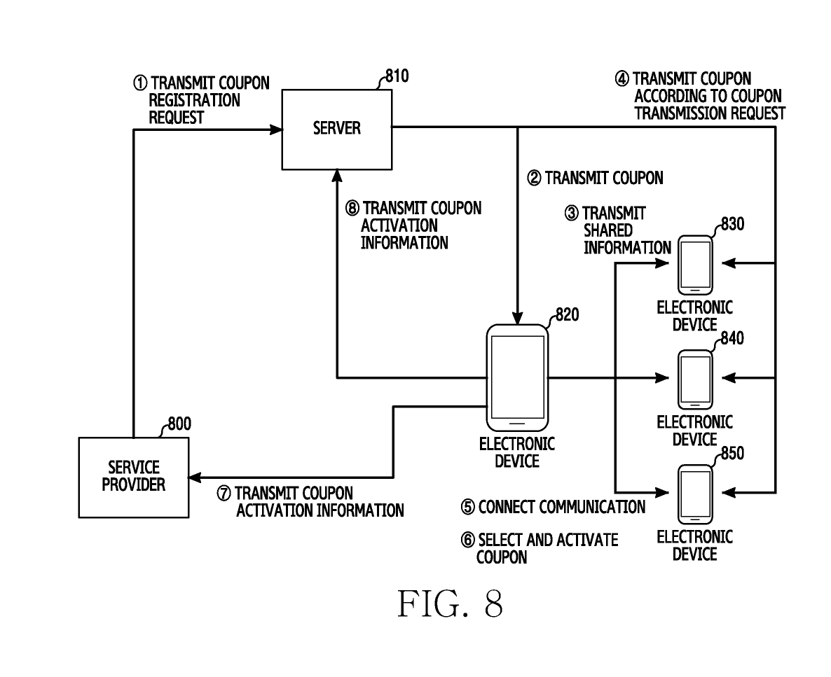

FIG. 8 illustrates a sequence diagram of an operation in a network environment for providing a coupon service according to various exemplary embodiments of the present disclosure.

Referring to FIG. 8, a service provider 800 may transmit a coupon registration request to a server 810. In response to the coupon registration request, the server 810 may transmit a coupon to an electronic device 820. Herein, the coupon may be an inactivated coupon. The electronic device 820 which receives the coupon may transmit shared information of the coupon to at least one electronic device connected to the electronic device 820 (e.g., an electronic device 830, an electronic device 840, and an electronic device 850). Herein, the shared information of the coupon may include at least one of identification information of the electronic device 820 which receives the coupon, identification information of the coupon, or resource information of the coupon. For example, the identification information of the electronic device 820 may include an ID, an identifier, and the like of the electronic device. The identification information of the coupon may include a coupon number of the coupon, information on a store in which the coupon can be used, information on goods to which the coupon can be applied, and the like. The resource information of the coupon may include source information of the coupon such as a URL address of a server from which the coupon is provided, and the like.

The at least one electronic device (e.g., the electronic device 830, the electronic device 840, and the electronic device 850) which receives the shared information of the coupon may transmit a coupon transmission request to the server 810 through the resource information included in the shared information, and may receive a coupon from the server 810 according to the coupon transmission request. Accordingly, the at least one electronic device (e.g., the electronic device 830, the electronic device 840, and the electronic device 850) may have the same coupon.

The electronic device 820 may try to connect communication with the at least one electronic device (e.g., the electronic device 830, the electronic device 840, and the electronic device 850) which receives the shared information, and, when the coupon is selected, may activate the coupon based on the number of connected electronic devices. Thereafter, the electronic device 820 may finish the use of the coupon by transmitting coupon activation information to the service provider 800 or the server 810.

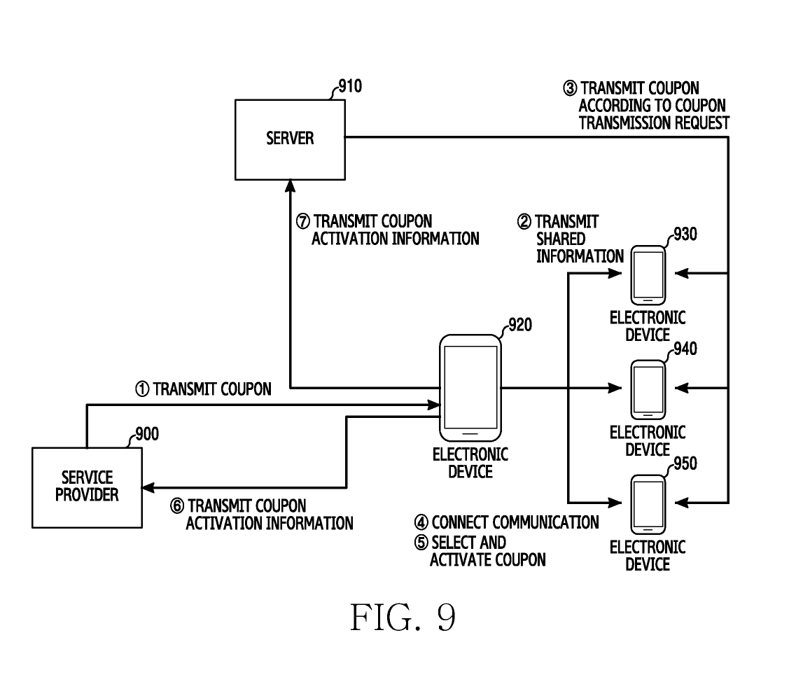

FIG. 9 illustrates a sequence diagram of an operation in a network environment for providing a coupon service according to various exemplary embodiments of the present disclosure.

Referring to FIG. 9, a service provider 900 may transmit a coupon to an electronic device 920. Herein, the coupon may be an inactivated coupon. The electronic device 920 which receives the coupon may transmit shared information of the coupon to at least one electronic device connected to the electronic device 920 (e.g., an electronic device 930, an electronic device 940, and an electronic device 950). Herein, the shared information of the coupon may include at least one of identification information of the electronic device 920 which receives the coupon, identification information of the coupon, or resource information of the coupon. For example, the identification information of the electronic device 920 may include an ID, an identifier, and the like of the electronic device. The identification information of the coupon may include a coupon number of the coupon, information on a store in which the coupon can be used, information on goods to which the coupon can be applied, and the like. The resource information of the coupon may include source information of the coupon such as a URL address of a server from which the coupon is provided, and the like.

The at least one electronic device (e.g., the electronic device 930, the electronic device 940, and the electronic device 950) which has receives the shared information of the coupon may transmit a coupon transmission request to the server 910 through the resource information included in the shared information, and may receive a coupon from the server 910 according to the coupon transmission request. Accordingly, the at least one electronic device (e.g., the electronic device 930, the electronic device 940, and the electronic device 950) may have the same coupon.

The electronic device 920 may try to connect communication with the at least one electronic device (e.g., the electronic device 930, the electronic device 940, and the electronic device 950) which receives the shared information, and, when the coupon is selected, may activate the coupon based on the number of connected electronic devices. Thereafter, the electronic device 920 may finish the use of the coupon by transmitting coupon activation information to the service provider 900 or the server 910.

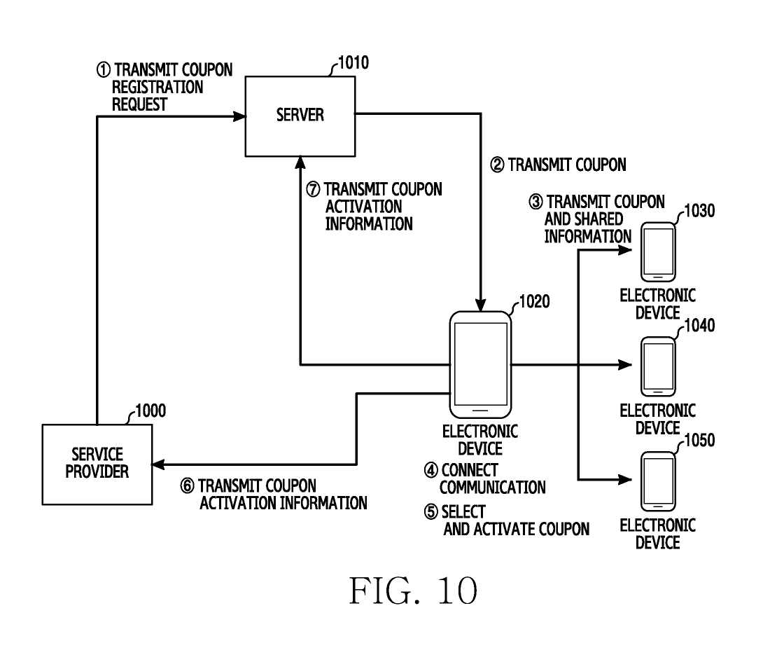

FIG. 10 illustrates a sequence diagram of an operation in a network environment for providing a coupon service according to various exemplary embodiments of the present disclosure.

Referring to FIG. 10, a service provider 1000 may transmit a coupon registration request to a server 1010. In response to the coupon registration request, the server 1010 may transmit a coupon to an electronic device 1020. Herein, the coupon may be an inactivated coupon. The electronic device 1020 which receives the coupon may transmit the coupon and shared information of the coupon to at least one electronic device (e.g., an electronic device 1030, an electronic device 1040, and an electronic device 1050) connected to the electronic device 1020. Herein, the shared information of the coupon may include at least one of identification information of the electronic device 1020 which receives the coupon or identification information of the coupon. For example, the identification information of the electronic device 1020 may include an ID, an identifier, and the like of the electronic device. The identification information of the coupon may include a coupon number of the coupon, information on a store in which the coupon can be used, information on goods to which the coupon can be applied, and the like. Accordingly, the at least one electronic device (e.g., the electronic device 1030, the electronic device 1040, and the electronic device 1050) may have the same coupon.

The electronic device 1020 may try to connect communication with the at least one electronic device (e.g., the electronic device 1030, the electronic device 1040, and the electronic device 1050) which receives the coupon and the shared information of the coupon, and, when the coupon is selected, may activate the coupon based on the number of connected electronic devices. Thereafter, the electronic device 1020 may finish the use of the coupon by transmitting the coupon activation information to the service provider 1000 or the server 1010.

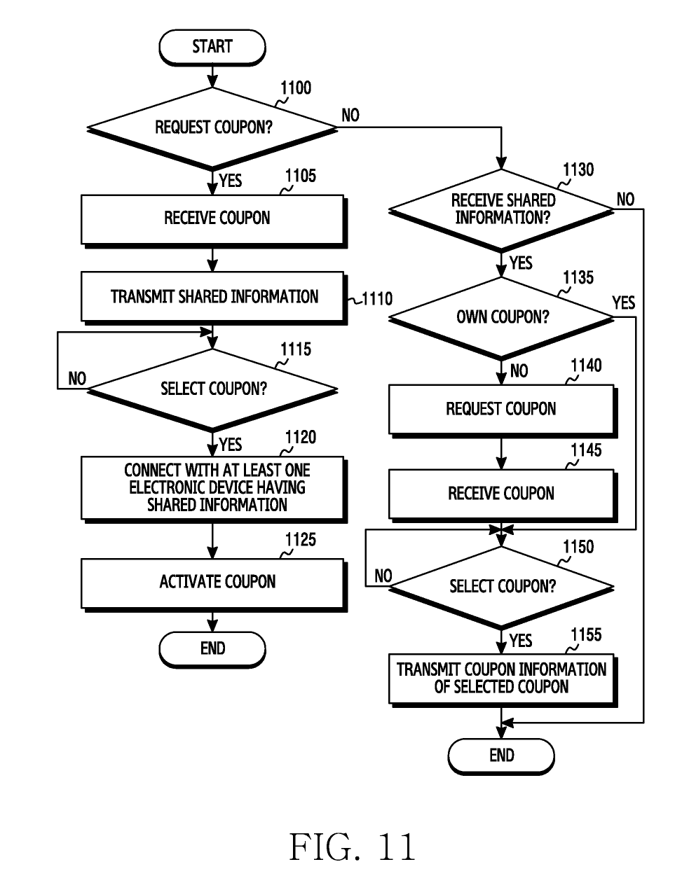

FIG. 11 illustrates a flowchart showing an operation method of an electronic device for providing a coupon service according to various exemplary embodiments of the present disclosure.

Referring to FIG. 11, in operation 1100, an electronic device (e.g., the electronic device 100) may determine whether the electronic device tries to request a coupon from a server or a service provider.

When the electronic device tries to request the coupon, the electronic device may receive the coupon from the server or the service provider in operation 1105. Herein, the coupon may be an inactivated coupon.

In operation 1110, the electronic device may transmit shared information of the coupon to at least one electronic device. Herein, the shared information of the coupon may include at least one of identification information of the electronic device which receives the coupon, identification information of the coupon, or resource information of the coupon. For example, the identification information of the electronic device may include an ID, an identifier, and the like of the electronic device. The identification information of the coupon may include a coupon number of the coupon, information on a store in which the coupon can be used, or information on goods to which the coupon can be applied. The resource information of the coupon may include source information of the coupon such as a URL address of a server from which the coupon is provided, and the like.

In operation 1115, the electronic device may determine whether the coupon is selected or not.

When the coupon is selected, the electronic device may be connected with the at least one electronic device having the shared information in operation 1120. According to various exemplary embodiments, when the coupon is selected, the electronic device may be automatically connected with the electronic device having the shared information. For example, the electronic device may transform to a connection standby state by selecting the coupon. Thereafter, the electronic device may serve as an AP which performs short-distance communication including at least one of WiFi communication, Bluetooth communication, or NFC. When the electronic device detects an electronic device having the shared information within the communication range of the above-described communication, the electronic device may be connected with the corresponding electronic device.

According to various exemplary embodiments, when the coupon is selected, the electronic device may be manually connected with the electronic device having the shared information. For example, the electronic device may transform to a connection standby state by selecting the coupon. Thereafter, the electronic device may serve as an AP which performs short-distance communication including at least one of WiFi communication, Bluetooth communication, or NFC. When the electronic device having the shared information is located within the communication range of the above-described communication and the corresponding coupon is selected, the electronic device may be connected with the electronic device serving as the AP.

According to various exemplary embodiments, the electronic device may set a password for connecting with the electronic device having the shared information. For example, the electronic device may receive a password from the electronic device having the shared information, and may be connected with the electronic device having the shared information based on the received password.

In operation 1125, the electronic device may activate the coupon. According to various exemplary embodiments, the electronic device may activate the coupon based on the number of connected electronic devices. For example, the coupon may be an inactivated coupon, and, when the number of connected electronic devices is greater than or equal to a reference number, the electronic device may activate the corresponding coupon.

According to various exemplary embodiments, the electronic device may activate the coupon by applying a different coupon benefit according to the number of connected electronic devices (e.g., by applying a different discount rate according to the number of members in a group).

On the other hand, when the electronic device does not try to request a coupon in operation 1100, the electronic device may determine whether the electronic device receives shared information of a coupon from the connected electronic device in operation 1130.

In operation 1135, the electronic device may determine whether the electronic device owns the corresponding coupon through the shared information.

When the electronic device owns the same coupon, the electronic device proceeds to operation 1150.

When the electronic device does not own the same coupon, the electronic device may request a coupon from a server or a service provider in operation 1140.

In operation 1145, the electronic device may receive the corresponding coupon from the server or the service provider.

In operation 1150, the electronic device may determine whether the coupon is selected or not.

When the coupon is selected, the electronic device may transmit the coupon information of the selected coupon to the connected electronic device in operation 1155.

An operation method of an electronic device according to various exemplary embodiments includes: receiving a coupon; functionally connecting with at least one electronic device; transmitting shared information of the coupon to the connected electronic device; when the coupon is selected, functionally connecting with the electronic device having the shared information; activating the coupon based on a number of the connected electronic devices; and transmitting the activated coupon to a payment device.

According to various exemplary embodiments, the shared information may include at least one of identification information of the electronic device, identification information of the coupon, or resource information of the coupon.

According to various exemplary embodiments, the functionally connecting with the electronic device having the shared information may include connecting with the electronic device having the shared information through short-distance communication.

According to various exemplary embodiments, the functionally connecting with the electronic device having the shared information may include: setting a password for the connecting; receiving a password from the electronic device having the shared information; and connecting with the electronic device having the shared information based on the received password.

According to various exemplary embodiments, the short-distance communication may include at least one of WiFi communication, Bluetooth communication, or NFC.

According to various exemplary embodiments, the receiving the coupon may include receiving the coupon from a server or a service provider.

According to various exemplary embodiments, the transmitting the shared information of the coupon to the connected electronic device may include transmitting the shared information of the coupon and the coupon to the connected electronic device.

According to various exemplary embodiments, the operation method may further include receiving payment information on the coupon from the payment device.

According to various exemplary embodiments, the operation method may further include: receiving shared information of a coupon from the connected electronic device; requesting the coupon from the payment device; receiving the requested coupon; and, when the coupon is selected, transmitting coupon information of the coupon to the connected electronic device.

According to various exemplary embodiments, the operation method may further include, when the shared information of the coupon is received, determining whether the electronic device owns the coupon or not, and, when the electronic device owns the coupon, the electronic device may not request the coupon.

The term “module” used in the present document may represent, for example, a unit including a combination of one or two or more of hardware, software, or firmware. The “module” may be, for example, used interchangeably with the terms “unit”, “logic”, “logical block”, “component”, or “circuit” etc. The “module” may be the minimum unit of an integrally constructed component or a part thereof. The “module” may be also the minimum unit performing one or more functions or a part thereof. The “module” may be implemented mechanically or electronically. For example, the “module” may include at least one of an Application-Specific Integrated Circuit (ASIC) chip, Field—Programmable Gate Arrays (FPGAs) and a programmable-logic device performing some operations known to the art or to be developed in the future.

At least a part of an apparatus (e.g., modules or functions thereof) or method (e.g., operations) according to various exemplary embodiments may be, for example, implemented as instructions stored in a computer-readable storage medium in a form of a programming module. In case that the instruction is executed by a processor (e.g., processor 120), and the processor may perform functions corresponding to the instructions. The computer-readable storage media may be the memory 130, for instance.

The computer-readable recording medium may include a hard disk, a floppy disk, and a magnetic medium (e.g., a magnetic tape), an optical medium (e.g., a Compact Disc—Read-Only Memory (CD-ROM) and a Digital Versatile Disc (DVD)), a Magneto-Optical Medium (e.g., a floptical disk), and a hardware device (e.g., a Read-Only Memory (ROM), a Random Access Memory (RAM), a flash memory, etc.). Also, the program instruction may include not only a mechanical language code such as a code made by a compiler but also a high-level language code executable by a computer using an interpreter, etc. The aforementioned hardware device may be constructed to operate as one or more software modules in order to perform operations of various exemplary embodiments, and vice versa.

The module or programming module according to various exemplary embodiments may include at least one or more of the aforementioned constituent elements, or omit some of the aforementioned constituent elements, or further include additional other constituent elements. Operations carried out by the module, the programming module or the other constituent elements according to various exemplary embodiments may be executed in a sequential, parallel, repeated or heuristic method. Also, some operations may be executed in different order or may be omitted, or other operations may be added.

And, an exemplary embodiment disclosed in the present document is suggested for the sake of describing and understanding of disclosed technology content, and does not limit the scope of the present disclosure. Accordingly, it should be understood that the scope of the present disclosure includes all modifications or various other exemplary embodiments based on a technological spirit of the present disclosure.

The method for providing a coupon service and the electronic device thereof according to various exemplary embodiments may link electronic devices owning the same coupon, and activate a coupon based on the linked electronic devices, so that coupon availability can be improved and customers in groups can be attracted.

1. A method for operating an electronic device, comprising:
receiving a coupon;
connecting with at least one electronic device;
transmitting shared information of the coupon to the at least one device connected;
connecting with the at least one electronic device having the shared information if the coupon is selected;
activating the coupon based on a number of the at least one electronic device; and
transmitting the coupon activated to a payment device.

2. The method of claim 1, wherein the shared information comprises at least one of identification information of the electronic device, identification information of the coupon, or resource information of the coupon.

3. The method of claim 1, wherein connecting with the at least one electronic device having the shared information comprises connecting with the at least one electronic device having the shared information through short-distance communication.

4. The method of claim 3, wherein connecting with the at least one electronic device having the shared information comprises:
setting a password for the connecting;
receiving the password from the at least one electronic device having the shared information; and
connecting with the at least one electronic device having the shared information based on the password received.

5. The method of claim 3, wherein the short-distance communication comprises at least one of WiFi communication, Bluetooth communication, or NFC.

6. The method of claim 1, wherein receiving the coupon comprises receiving the coupon from a server or a service provider.

7. The method of claim 1, wherein transmitting the shared information of the coupon to the at least one electronic device connected comprises transmitting the shared information of the coupon and the coupon to the at least one electronic device connected.

8. The method of claim 1, further comprising receiving payment information on the coupon from the payment device.

9. The method of claim 1, further comprising:
receiving shared information of a coupon from the at least one electronic device connected;
requesting the coupon from the payment device;
receiving the coupon requested; and
transmitting coupon information of the coupon to the at least one electronic device connected if the coupon is selected.

10. The method of claim 9, further comprising:
determining whether the at least one electronic device owns the coupon or not if the shared information of the coupon is received, and
wherein the at least one electronic device does not request the coupon if the at least one electronic device owns the coupon.

11. An electronic device comprising:
a communication interface; and
at least one processor functionally connected with the communication interface,
wherein the processor is configured to:
connect with at least one electronic device if a coupon is received;
transmit shared information of the coupon to the at least one electronic device connected;
connect with the at least one electronic device having the shared information if the coupon is selected;
activate the coupon based on a number of the at least one electronic device connected; and
transmit the coupon activated to a payment device.

12. The electronic device of claim 11, wherein the shared information comprises at least one of identification information of the at least one electronic device, identification information of the coupon, or resource information of the coupon.

13. The electronic device of claim 11, wherein the processor is configured to connect with the at least one electronic device having the shared information through short-distance communication.

14. The electronic device of claim 13, wherein the processor is configured to:
set a password for connecting with the at least one electronic device having the shared information;
receive the password from the at least one electronic device having the shared information; and
connect with the at least one electronic device having the shared information based on the password received.

15. The electronic device of claim 13, wherein the short-distance communication comprises at least one of WiFi communication, Bluetooth communication, or NFC.

16. The electronic device of claim 11, wherein the processor is configured to receive the coupon from at least one of a server and a service provider.

17. The electronic device of claim 11, wherein the processor is configured to transmit the shared information of the coupon and the coupon to the at least one electronic device connected.

18. The electronic device of claim 11, wherein the processor is configured to receive payment information on the coupon from the payment device.

19. The electronic device of claim 11, wherein the processor is configured to:
receive shared information of a coupon from the at least one electronic device connected;
request the coupon from the payment device;
receive the coupon requested; and
transmit coupon information of the coupon to the at least one electronic device connected if the coupon is selected.

20. The electronic device of claim 19, wherein the processor is configured to determine whether the at least one electronic device owns the coupon or not if the shared information of the coupon is received, and to not request the coupon if the at least one electronic device owns the coupon.
